(19) United States
(12) Patent Application Publication
(10) Pub. No.: US 2023/0415227 A1
(43) Pub. Date: Dec. 28, 2023

(54) PRODUCTION METHOD FOR PHOSPHATE-COATED SmFeN-BASED ANISOTROPIC MAGNETIC POWDER, AND BONDED MAGNET

(71) Applicant: NICHIA CORPORATION, Anan-shi (JP)

(72) Inventors: Masahiro ABE, Tokushima-shi (JP); Satoshi YAMANAKA, Tokushima-shi (JP); Shuichi TADA, Komatsushima-shi (JP); Kenta IWAI, Anan-shi (JP)

(73) Assignee: NICHIA CORPORATION, Anan-shi (JP)

(21) Appl. No.: 18/253,676

(22) PCT Filed: Sep. 30, 2021
(86) PCT No.: PCT/JP2021/036189

§ 371 Date: May 19, 2023

(30) Foreign Application Priority Data
Nov. 19, 2020 (JP) 2020-192545

(51) Int. Cl. B22F 1/16; H01F 1/059; H01F 1/055; B22F 1/145; B22F 1/142; B22F 1/103; B22F 9/20; B22F 3/20; B22F 3/22

(52) U.S. Cl. CPC B22F 1/16; B22F 2999/00; H01F 1/0551; B22F 1/145; B22F 1/142; B22F 1/103; B22F 9/20; B22F 3/20; B22F 3/225; B22F 2301/355; B22F 2302/45; B22F 2998/10; B22F 2201/02; B22F 2201/11; B22F 2202/05; H01F 1/059

(57) ABSTRACT

A method for producing a phosphate-coated SmFeN-based anisotropic magnetic powder, the method includes: a phosphate treatment of adding an inorganic acid to a slurry containing an SmFeN-based anisotropic magnetic powder, water, and a phosphate compound to adjust a pH of the slurry to a range from 1 to 4.5 to form an SmFeN-based anisotropic magnetic powder having a surface on which a phosphate coating is formed; and oxidizing by heat treating the SmFeN-based anisotropic magnetic powder having the surface on which the phosphate coating is formed, in an oxygen-containing atmosphere at a temperature in a range of 200° C. to 330° C., to form the phosphate-coated SmFeN-based anisotropic magnetic powder.

### CROSS-REFERENCE TO RELATED APPLICATION

This application claims priority to Japanese Patent Application No. 2020-192545, filed on Nov. 19, 2020, the disclosure of which is hereby incorporated by reference in its entirety.

### BACKGROUND

The present invention is related to a method for producing a phosphate-coated SmFeN-based anisotropic magnetic powder and to a bonded magnet.

A bonded magnet in which an SmFeN-based anisotropic magnetic powder is used is known as a composite member for use in a motor used in a water-containing environment, such as a water pump. A demand exists for a bonded magnet that excels not only in water resistance and corrosion resistance (oxidation resistance), but also in hot water resistance, particularly for in-vehicle applications. For example, Japanese Patent Publication No. 2020-050904 indicates that hot water resistance can be improved by surface-treating an SmFeN-based anisotropic magnetic powder with a plasma-treated gas, and then forming a coating layer.

It is also known that coercivity is improved by forming a phosphate coating on the surface of SmFeN-based anisotropic magnetic powder. For example, Japanese Patent Publication No. 2020-056101 discloses a method for forming a phosphate coating on the surface of an SmFeN-based anisotropic magnetic powder by adding a phosphate treatment solution containing a pH-adjusted ortho-phosphoric acid to a slurry containing an SmFeN-based anisotropic magnetic powder in which water is used as a solvent.

Japanese Patent Publication No. 2017-210662 discloses a method of adding a pH-adjusted phosphate treatment solution to a slurry containing an SmFeN-based anisotropic magnetic powder having a large particle size in which an organic solvent is used as the solvent, and subsequently grinding the SmFeN-based anisotropic magnetic powder to thereby form small particles and form a phosphate coating on the surface of the SmFeN-based anisotropic magnetic powder.

Japanese Patent Publication No. 2014-160794 indicates that the coercivity of a magnetic powder is increased by subjecting an SmFeN-based anisotropic magnetic powder, on which a phosphate coating is formed, to a gradual oxidation treatment.

### CITATION LIST

### Summary

An object of the present invention is to provide a method for producing an anisotropic magnetic powder having good hot water resistance and to provide a bonded magnet.

A method for producing a phosphate-coated SmFeN-based anisotropic magnetic powder according to one aspect of the present invention includes: a phosphate treatment of adding an inorganic acid to a slurry containing an SmFeN-based anisotropic magnetic powder, water, and phosphate compounds to adjust the pH of the slurry to a range from 1 to 4.5 to form a phosphate-coated SmFeN-based anisotropic magnetic powder having a surface coated with a phosphate; and
oxidizing by heat treating the phosphate-coated SmFeN-based anisotropic magnetic powder in an oxygen-containing atmosphere at a temperature in a range from 200° C. to 330° C.

Moreover, a bonded magnet according to one aspect of the present invention contains polypropylene and a phosphate-coated SmFeN-based anisotropic magnetic powder having a phosphate content of greater than 0.5 mass %, and a retention rate of the total flux after a test of immersing the bonded magnet in 120° C. hot water and maintaining that state for 1000 hours is 95% or greater of the total flux before the test.

A magnetic powder according to one aspect of the present invention is a phosphate-coated SmFeN-based anisotropic magnetic powder, wherein the content of phosphate is greater than 0.5 mass %, a phosphate coating present on a surface of the SmFeN-based anisotropic magnetic powder includes a first region and a second region,
the Sm atomic concentration in the first region is higher than the Sm atom concentration in the SmFeN-based anisotropic magnetic powder,
the Sm atomic concentration of the first region is in a range from 0.5 times to 4 times an Fe atomic concentration in the first region, and the second region is present on the first region, and the Sm atomic concentration of the second region is not more than ⅓ times the Fe atomic concentration in the second region.

According to the aspects described above, a method for producing an anisotropic magnetic powder having good hot water resistance, and a bonded magnet can be provided.

### BRIEF DESCRIPTION OF DRAWINGS

FIG. 1 is a graph illustrating the relationship between the immersion time and an irreversible flux loss of a bonded magnet under hot water immersion conditions.

FIG. 2 is a table presenting STEM-EDX mapping analysis results of magnetic powders of Example 1 and Comparative Example 2.

FIG. 3 is a graph of the results of EDX line analysis of the magnetic powder of Example 1.

FIG. 4 is a graph of the results of EDX line analysis of the magnetic powder of Comparative Example 2.

FIG. 5 is a schematic view of one embodiment of the phosphate coating.

### DESCRIPTION OF EMBODIMENT

Embodiments of the present invention will be described below. The following embodiments are examples for embodying the technical concept of the present invention, and are not intended to limit the present invention. Note that herein, the word “step” is included in the present terminology if the anticipated purpose of the step is achieved in the case of not only an independent step, but also a step that cannot be clearly distinguished from another step. Also, a numerical range indicated by “from x to y” indicates a range including the numerical values indicated by x and y as the minimum value and the maximum value, respectively.

### Method for Producing Phosphate-Coated SmFeN-Based Anisotropic Magnetic Powder

The method for producing a phosphate-coated SmFeN-based anisotropic magnetic powder according to the present embodiment is characterized by including:
a phosphate treatment step of adding an inorganic acid to a slurry containing an SmFeN-based anisotropic magnetic powder, water, and a phosphate compound to adjust the pH of the slurry to a range from 1 to 4.5 to thereby form a phosphate-coated SmFeN-based anisotropic magnetic powder having a surface coated with a phosphate; and
an oxidation step of heat treating the phosphate-coated SmFeN-based anisotropic magnetic powder in an oxygen-containing atmosphere at a temperature in a range from 200° C. to 330° C.

In the phosphate treatment step, an inorganic acid is added to a slurry containing an SmFeN-based anisotropic magnetic powder, water, and a phosphate compound, and the pH of the slurry is adjusted to a range from 1 to 4.5 to thereby form an SmFeN-based anisotropic magnetic powder having a surface coated with a phosphate. The phosphate-coated SmFeN-based anisotropic magnetic powder is formed by reacting a metal component (for example, iron or samarium) contained in the SmFeN-based anisotropic magnetic powder and a phosphate component contained in the phosphate compound, and thereby depositing a phosphate (for example, iron phosphate or samarium phosphate) on the surface of the SmFeN-based anisotropic magnetic powder. According to the present embodiment, in comparison to a case in which an inorganic acid is not added, the deposition amount of the phosphate can be increased by adding an inorganic acid to adjust the pH to a range from 1 to 4.5, and therefore a phosphate-coated SmFeN-based anisotropic magnetic powder in which the thickness of the coating is thick can be formed. Furthermore, according to the present embodiment, in comparison to a case in which an organic solvent is used as the solvent, a phosphate having a small particle size is deposited by using water as the solvent, and therefore a phosphate-coated SmFeN-based anisotropic magnetic powder in which the coating is dense can be formed.

Subsequently, in the oxidation step, the formed phosphate-coated SmFeN-based anisotropic magnetic powder is heat-treated at a high temperature in a range from 200° C. to 330° C. in an oxygen-containing atmosphere. It is conceivable that as a result, the hot water resistance of the phosphate-coated SmFeN-based anisotropic magnetic powder is improved because the surface coated by the phosphate of the SmFeN-based anisotropic magnetic powder, which is the base, is oxidized, and a thick iron oxide layer is formed.

### Phosphate Treatment Step

The method for producing a slurry containing an SmFeN-based anisotropic magnetic powder, water, and a phosphate compound is not particularly limited, but for example, the slurry can be formed by using water as a solvent and mixing the SmFeN-based anisotropic magnetic powder with an aqueous phosphate solution containing a phosphate compound. The content of the SmFeN-based anisotropic magnetic powder in the slurry is, for example, in a range from 1 mass % to 50 mass %, and from the perspective of productivity, the content thereof is preferably in a range from 5 mass % to 20 mass %. The content of the phosphate component (PO₄) in the slurry in terms of the amount of PO₄ is, for example, in a range from 0.01 mass % to 10 mass %, and from the perspectives of productivity and reactivity of the phosphate component, the content thereof is preferably in a range from 0.05 mass % to 5 mass %.

The aqueous phosphate solution is formed by mixing a phosphate compound and water. Examples of the phosphate compound include phosphate-based compounds, such as ortho-phosphoric acid, sodium dihydrogen phosphate, sodium hydrogen phosphate, ammonium dihydrogen phosphate, ammonium hydrogen phosphate, zinc phosphate, and calcium phosphate, hypophosphorous acid-based compounds, hypophosphite-based compounds, pyrophosphate-based compounds, polyphosphate-based compounds, and other such inorganic phosphates, and organic phosphates. A single type of these phosphate compounds may be used alone, or a combination of two or more may be used. In addition, an oxoacid salt such as molybdate, tungstate, vanadate, and chromate, an oxidant such as sodium nitrate and sodium nitrite, and a chelating agent such as EDTA may be further added for the purpose of improving the water resistance and corrosion resistance by the coating, and the magnetic properties of the magnetic powder.

The concentration (in terms of PO₄) of the phosphate in the aqueous phosphate solution is, for example, in a range from 5 mass % to 50 mass %, and from the perspectives of the solubility of the phosphate compound, storage stability, and ease of the oxidation treatment, the concentration thereof is preferably in a range from 10 mass % to 30 mass %. The pH of the aqueous phosphate solution is, for example, in a range from 1 to 4.5, and from the perspective of facilitating control of the deposition rate of the phosphate, the pH thereof is preferably in a range from 1.5 to 4. The pH can be adjusted using dilute hydrochloric acid, dilute sulfuric acid, or the like.

In the phosphate treatment step, an inorganic acid is added to adjust the pH of the slurry to a range from 1 to 4.5, preferably to a range from 1.6 to 3.9, and more preferably to a range from 2 to 3. If the pH is less than 1, coercivity tends to decrease because phosphate is deposited in a localized manner in large amounts, triggering aggregation of the phosphate-coated SmFeN-based anisotropic magnetic powder. If the pH exceeds 4.5, coercivity tends to decrease because the deposited amount of phosphate decreases and thereby the coating becomes insufficient. Examples of the inorganic acid that is added include hydrochloric acid, nitric acid, sulfuric acid, boric acid, and hydrofluoric acid. During the phosphate treatment step, the inorganic acid is added as needed such that the pH is within the range described above. An inorganic acid is used from the perspective of waste liquid treatment, but an organic acid can be used in combination according to the purpose. Examples of the organic acid include acetic acid, formic acid, and tartaric acid. A mixed solution of an inorganic acid and an organic acid may be used.

The phosphate treatment step may be implemented such that the lower limit of the phosphate content in the resulting phosphate-coated SmFeN-based anisotropic magnetic powder is greater than 0.5 mass %. The lower limit of the phosphate content of the phosphate-coated SmFeN-based anisotropic magnetic powder formed in the phosphate treatment step is preferably 0.55 mass % or greater, and particularly preferably 0.75 mass % or greater, and the upper limit of the phosphate content is 4.5 mass % or less, preferably 2.5 mass % or less, and particularly preferably 2 mass % or less. When the phosphate content is not greater than 0.5 mass %, the effect of coating with the phosphate tends to be reduced, and when the phosphate content exceeds 4.5 mass %, the phosphate-coated SmFeN-based anisotropic magnetic powder tends to aggregate, and coercivity tends to decrease. Note that the phosphate content in the magnetic powder is expressed in terms of the amount of PO₄ molecules measured using inductively coupled plasma atomic emission spectroscopy (ICP-AES).

Adjusting the pH of slurry containing an SmFeN-based anisotropic magnetic powder, water, and a phosphate compound to a range from 1 to 4.5 can be performed over a period of 10 minutes or longer, and from the perspective of reducing portions of the coating at which the thickness is thin, adjusting the pH is preferably performed over a period of 30 minutes or longer. At the initial stage of pH maintenance, the pH rises rapidly, and therefore the interval between each introduction of the inorganic acid for pH control is short. However, as the coating progresses, changes in pH gradually slow down, and the interval between each introduction of the inorganic acid becomes longer, and therefore the reaction end point can be determined.

Oxidation Step after Phosphate Treatment

In the oxidation step after the phosphate treatment, the phosphate-coated SmFeN-based anisotropic magnetic powder formed in the phosphate treatment step is subjected to an oxidation treatment by heat treating at a temperature in a range from 200° C. to 330° C. in an oxygen-containing atmosphere. By heat treating the phosphate-coated SmFeN-based anisotropic magnetic powder at a high temperature in a range from 200° C. to 330° C. in an oxygen-containing atmosphere, the surface coated by the phosphate of the SmFeN-based anisotropic magnetic powder, which is the base, is oxidized, and a thick iron oxide layer is formed, and thereby the hot water resistance of the phosphate-coated SmFeN-based anisotropic magnetic powder is improved.

The oxidation step after the phosphate treatment is carried out by heat treating the phosphate-coated SmFeN-based anisotropic magnetic powder in an oxygen-containing atmosphere. The reaction atmosphere preferably contains oxygen in an inert gas such as nitrogen or argon. The oxygen concentration is preferably in a range from 3% to 21%, and more preferably in a range from 3.5% to 10%. During the oxidation reaction, gas is preferably exchanged at a flow rate in a range from 2 L/min to 10 L/min in relation to 1 kg of the magnetic powder.

The heat treatment temperature in the oxidation step after the phosphate treatment is in a range from 200° C. to 330° C., preferably in a range from 200° C. to 250° C., and more preferably in a range from 210° C. to 230° C. At a temperature of less than 200° C., production of the iron oxide layer is insufficient, and the hot water resistance tends to decrease. When the temperature exceeds 330° C., the iron oxide layer is formed in excess, and the coercivity tends to decrease. The heat treatment time is preferably in a range from 3 hours to 10 hours.

The oxidation step after the phosphate treatment is preferably implemented such that the phosphate coating present on the surface of the SmFeN-based anisotropic magnetic powder has a first region, the Sm atomic concentration in the first region is higher than the Sm atomic concentration in the SmFeN-based anisotropic magnetic powder, and the Sm atomic concentration in the first region is in a range from 0.5 times to 4 times an Fe atomic concentration in the first region. The Sm atomic concentration in the first region can be, in relation to the Sm atomic concentration in the SmFeN-based anisotropic magnetic powder, 1.02 times or more, preferably 1.05 times or more, more preferably 1.1 times or more, and even more preferably 1.2 times or more. In addition, the Sm atomic concentration in the first region can be not more than three times the Sm atomic concentration in the SmFeN-based anisotropic magnetic powder. The Sm atomic concentration in the first region is preferably, in relation to the Fe atomic concentration in the first region, in a range from 0.6 times to 3.5 times, and more preferably in a range from 0.7 times to 3 times. The atomic concentrations (atm %) in the SmFeN-based anisotropic magnetic powder and in the first region are determined by averaging regional atomic concentrations (atm %) output from STEM-EDX line analysis.

### Phosphate-Coated SmFeN-Based Anisotropic Magnetic Powder

The phosphate-coated SmFeN-based anisotropic magnetic powder according to the present embodiment is characterized by having a phosphate content of greater than mass %. Note that the phosphate-coated SmFeN-based anisotropic magnetic powder is formed by the method described above.

The exothermic onset temperature of the phosphate-coated SmFeN-based anisotropic magnetic powder according to DSC is preferably 170° C. or higher, more preferably 200° C. or higher, and particularly preferably 260° C. or higher. The exothermic onset temperature according to DSC is a comprehensive evaluation of properties such as the density, thickness, and oxidation resistance of the phosphate coating, and high coercivity occurs when the exothermic onset temperature is 170° C. or higher. Note that the exothermic onset temperature according to DSC can be measured under the conditions described in the examples.

The phosphate-coated SmFeN-based anisotropic magnetic powder is preferably such that in an XRD diffraction pattern, a ratio (I)/(II) of a diffraction peak intensity (I) of a (110) plane of αFe to a peak intensity (II) of a (300) plane of the SmFeN-based magnetic powder is 2.0×10⁻² or less, and more preferably 1.0×10⁻² or less. The diffraction peak intensity (I) of the αFe (110) plane represents the presence amount of the impurity αFe, and when the ratio (I)/(II) described above is 2.0×10⁻² or less, high coercivity occurs. The diffraction peak intensity in the XRD diffraction pattern is measured with a powder X-ray crystal diffractometer (available from Rigaku Corporation, X-ray wavelength: CuKa1), and the αFe peak height ratio can be determined by dividing the measured diffraction peak intensity of the (110) plane of αFe by the peak intensity of the (300) plane of Sm₂Fe₁₇N₃ and then multiplying by 10000. A low αFe peak height ratio means that the content of αFe, which is an impurity, is low.

The carbon content of the phosphate-coated SmFeN-based anisotropic magnetic powder is preferably 1000 ppm or less, and more preferably 800 ppm or less. The carbon content indicates the amount of organic impurities in the phosphate, and when the carbon content exceeds 1000 ppm, organic impurities decompose and produce defects in the coating when the phosphate-coated SmFeN-based anisotropic magnetic powder is exposed to high temperatures in the process of fabricating a bonded magnet, and as a result, coercivity tends to decrease. Here, the carbon content can be measured by the TOC method.

From the perspective of the coercivity of the phosphate-coated SmFeN-based anisotropic magnetic powder, the thickness of the phosphate coating of the phosphate-coated SmFeN-based anisotropic magnetic powder is preferably in a range from 10 nm to 200 nm. Note that the thickness of the phosphate coating can be measured by carrying out a composition analysis through line analysis by EDX in a cross section of the phosphate-coated SmFeN-based anisotropic magnetic powder.

The phosphate coating present on the surface of the SmFeN-based anisotropic magnetic powder has a first region, the Sm atomic concentration in the first region is higher than the Sm atomic concentration in the SmFeN-based anisotropic magnetic powder, and the Sm atomic concentration in the first region is preferably in a range from 0.5 times to 4 times the Fe atomic concentration in the first region.

The Sm atomic concentration in the first region can be, in relation to the Sm atomic concentration in the SmFeN-based anisotropic magnetic powder, 1.02 times or more, preferably 1.05 times or more, more preferably 1.1 times or more, and even more preferably 1.2 times or more. In addition, the Sm atomic concentration in the first region can be not more than three times the Sm atomic concentration in the SmFeN-based anisotropic magnetic powder. The Sm atomic concentration in the first region is preferably, in relation to the Fe atomic concentration in the first region, in a range from 0.6 times to 3.5 times, and more preferably in a range from 0.7 times to 3 times. When the relationship between the Sm atomic concentration and the Fe atomic concentration in the first region is within the range described above, the Fe atomic concentration in the vicinity of the surface of the SmFeN-based anisotropic magnetic powder becomes low, and the content of samarium phosphate having low solubility in water is increased, and thereby water resistance tends to further improve.

Here, the first region is a region including a layer exhibiting a maximum peak of phosphorus (P) in a STEM-EDX line analysis of the phosphate-coated SmFeN-based anisotropic magnetic powder. The thickness of the first region can be in a range from 1 nm to 200 nm, and is preferably in a range from 3 nm to 100 nm. The atomic concentration (atm %) of each element in the first region, the below-described second region, and an Mo high concentration layer is determined by averaging regional atomic concentrations (atm %) output from STEM-EDX line analysis.

The phosphate coating further includes a second region on the first region, and the Sm atomic concentration in the second region is preferably not greater than ⅓ times the Fe atomic concentration in the second region. The Sm atomic concentration in the second region is, in relation to the Fe atomic concentration in the second region, more preferably ⅕ times or less, and even more preferably 1/10 times or less. The Sm atomic concentration of the second region can be set to 0 times or more the Fe atomic concentration of the second region. Here, the second region is a region containing a layer exhibiting a maximum peak of iron (Fe) in the phosphate coating, as determined in a STEM-EDX line pro-analysis of the phosphate-coated SmFeN-based anisotropic magnetic powder. The thickness of the second region can be in a range from 1 nm to 200 nm, and is preferably in a range from 5 nm to 100 nm. In a case in which the second region is provided on the first region as described above, a region containing iron is provided in addition to the phosphate coating, and therefore even in a case in which locations exist where the film thickness of the phosphate coating is relatively thin, reinforcing is achieved by the region containing iron, and water resistance tends to be further improved.

The Fe atomic concentration in the second region is, in relation to the Fe atomic concentration in the first region, preferably 2 times or greater, and more preferably 3 times or greater. The Fe atomic concentration in the second region is preferably not more than 10 times the Fe atomic concentration in the first region. In addition, the Fe atomic concentration in the second region is, in relation to the Fe atomic concentration in the SmFeN-based anisotropic magnetic powder serving as the base, preferably in a range from 0.25 times to 1 times, and more preferably in a range from 0.5 times to 0.8 times. The phosphorus (P) atomic concentration in the second region is preferably lower than the P atomic concentration in the first region. The P atomic concentration in the second region is, in relation to the P atomic concentration in the first region, preferably ⅕ times or less, and more preferably 1/10 times or less. By setting the P atomic concentration in the second region in the manner described above, the water resistance tends to be further improved.

When molybdate is blended in the reaction slurry in the phosphate treatment step, a high Mo-concentration layer may be present in the first region and the second region of the phosphate coating. Three high Mo-concentration layers are preferably present in the phosphate coating, that is, three peaks of molybdenum (Mo) are preferably present in a STEM-EDX line analysis of the phosphate-coated SmFeN-based anisotropic magnetic powder. The high Mo-concentration layer can also be confirmed by STEM-EDX mapping analysis. FIG. 5 is a schematic view of the phosphate coating in a case in which a high Mo-concentration layer is present on the outermost surface of the phosphate-coated SmFeN-based anisotropic magnetic powder serving as the base and also in the first region and on the outermost surface of the second region. Here, the high Mo-concentration region is a region including a layer exhibiting a peak of molybdenum (Mo) in a STEM-EDX line analysis of the phosphate-coated SmFeN-based anisotropic magnetic powder. The thickness of the high Mo-concentration layer is preferably in a range from 1 nm to 40 nm. In a case in which three high Mo-concentration layers are provided as described above, the phosphate coating is formed with a more layered structure, and thereby the water resistance tends to be improved.

The Mo atomic concentration in the high Mo-concentration layer is, in relation to the Mo atomic concentration of the first region other than the high Mo-concentration layer, preferably in a range from 1.1 times to 40 times, and more preferably in a range from 2 times to 20 times. The Mo atomic concentration in the high Mo-concentration layer is, in relation to the Mo atomic concentration of the second region other than the high Mo-concentration layer, preferably in a range from 1.1 times to 20 times, and more preferably in a range from 2 times to 10 times. Note that the Sm atomic concentration, the Fe atomic concentration, and the Mo atomic concentration can be measured by subjecting the phosphate-coated SmFeN-based anisotropic magnetic powder to a composition analysis through line analysis by EDX.

### Silica Treatment Step

After the phosphate treatment, the SmFeN-based anisotropic magnetic powder may be subjected to a silica treatment as necessary. Oxidation resistance can be improved by forming a silica thin film on the magnetic powder. The silica thin film can be formed, for example, by mixing an alkyl silicate, the phosphate-coated SmFeN-based anisotropic magnetic powder, and an alkaline solution.

### Silane Coupling Treatment Step

The magnetic powder after the silica treatment may be further treated with a silane coupling agent. A coupling agent film is formed on the silica thin film by subjecting the magnetic powder on which the silica thin film is formed to a silane coupling treatment, and thereby the magnetic properties of the magnetic powder are improved, and wettability with a resin and the strength of the magnet can be improved. The silane coupling agent is not particularly limited as long as it is selected in accordance with the type of resin, and examples of the silane coupling agent include 3-aminopropyl triethoxysilane, γ-(2-aminoethyl) aminopropyl trimethoxysilane, γ-(2-aminoethyl) aminopropylmethyl dimethoxysilane, γ-methacryloxypropyl trimethoxysilane, γ-methacryloxypropyl dimethoxysilane, N-β-(N-vinylbenzylaminoethyl)-γ-aminopropyl trimethoxysilane hydrochloride, γ-glycidoxypropyl trimethoxysilane, γ-mercaptopropyl trimethoxysilane, methyl trimethoxysilane, methyl triethoxysilane, vinyl triacetoxysilane, γ-chloropropyl trimethoxysilane, hexamethylene disilazane, γ-anilinopropyl trimethoxysilane, vinyl trimethoxysilane, octadecyl[3-(trimethoxysilyl)propyl]ammonium chloride, γ-chloropropylmethyl dimethoxysilane, γ-mercaptopropylmethyl dimethoxysilane, methyl trichlorosilane, dimethyl dichlorosilane, trimethylchlorosilane, vinyl trichlorosilane, vinyl tris(β-methoxyethoxy)silane, vinyl triethoxysilane, β-(3,4-epoxycyclohexyl)ethyl trimethoxysilane, γ-glycidoxypropylmethyl diethoxysilane, N-β(aminoethyl)γ-aminopropyl trimethoxysilane, N-β(aminoethyl)γ-aminopropylmethyl dimethoxysilane, γ-aminopropyl triethoxysilane, N-phenyl-γ-aminopropyl trimethoxysilane, oleidopropyl triethoxysilane, γ-isocyanatopropyl triethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyl trimethoxysilane, vinylmethyl dimethoxysilane, 1,3,5-N-tris(3-trimethoxysilylpropyl)isocyanurate, t-butylcarbamate trialkoxysilane, N-(1,3-dimethylbutylidene)-3-(triethoxysilyl)-1-propanamine. A single type of these silane coupling agents may be used alone, or two or more may be combined and used. The addition amount of the silane coupling agent is preferably in a range from 0.2 parts by weight to 0.8 parts by weight, and more preferably in a range from 0.25 parts by weight to 0.6 parts by weight, per 100 parts by weight of the magnetic powder. When the addition amount of the silane coupling agent is less than 0.2 parts by weight, the effect of the silane coupling agent is small, and when the addition amount exceeds 0.8 parts by weight, the magnetic properties of the magnetic powder and magnet tend to be reduced due to aggregation of the magnetic powder.

After the phosphate treatment step, after the oxidation step, and after the silane treatment or silane coupling treatment, the SmFeN-based anisotropic magnetic powder can be filtered, dehydrated, and dried by normal methods.

### Method for Producing SmFeN-Based Anisotropic Magnetic Powder

The SmFeN-based anisotropic magnetic powder used in the phosphate treatment step is not particularly limited, but, for example, an SmFeN-based anisotropic magnetic powder produced by the following method can be favorably used. Namely, the SmFeN-based anisotropic magnetic powder may be produced by a method including:
a step (precipitation step) of mixing a solution containing Sm and Fe and a precipitant to form a precipitate containing Sm and Fe;
a step (oxidation step) of firing the precipitate to form an oxide containing Sm and Fe;
a step (pretreatment step) of heat treating the oxide in an environment containing a reducing gas to form a partial oxide;
a step (reduction step) of reducing the partial oxide; and
a step (nitriding step) of subjecting alloy particles formed in the reduction step to a nitriding treatment.

### Precipitation Step

In the precipitation step, a solution containing Sm and Fe is prepared by dissolving an Sm raw material and an Fe raw material in a strongly acidic solution. When Sm₂Fe₁₇N₃ is formed as the main phase, the molar ratio of Sm and Fe (Sm:Fe) is preferably in a range from 1.5:17 to 3.0:17, and more preferably in a range from 2.0:17 to 2.5:17. Raw materials such as La, W, Co, Ti, Sc, Y, Pr, Nd, Pm, Gd, Tb, Dy, Ho, Er, Tm, and Lu may be added to the above-mentioned solution.

The Sm raw material and the Fe raw material are not limited as long as they can be dissolved in the strongly acidic solution. For example, in terms of ease of availability, an example of the Sm raw material includes samarium oxide, and an example of the Fe raw material includes FeSO₄. The concentration of the solution containing Sm and Fe can be adjusted, as appropriate, in a range in which the Sm raw material and the Fe raw material are substantially dissolved in the acidic solution. From the perspective of solubility, an example of the acidic solution includes sulfuric acid.

An insoluble precipitate containing Sm and Fe is formed by reacting the solution containing Sm and Fe with a precipitant. Here, the solution containing Sm and Fe need only be a solution containing Sm and Fe when reacted with the precipitant, and, for example, raw materials including Sm and Fe may be prepared as separate solutions, and each solution may be added dropwise to react with the precipitant. Even when prepared as separate solutions, appropriate adjustment is performed in a range in which each raw material is substantially dissolved in the acidic solution. The precipitant is not limited as long as it is an alkaline solution that reacts with the solution containing Sm and Fe to produce a precipitate. Examples of the precipitant include ammonia water and caustic soda, and caustic soda is preferable.

As the precipitation reaction, a method in which the precipitant and the solution containing Sm and Fe are each added dropwise to a solvent such as water is preferable because adjustment can be easily performed according to the properties of the precipitate particles. Details such as the supply rates of the precipitant and the solution containing Sm and Fe, the reaction temperature, the reaction solution concentration, and the pH during the reaction are appropriately controlled, and thereby a precipitate having a uniform distribution of constituent elements, a sharp particle size distribution, and a regulated powder shape is formed. The magnetic properties of the magnetic powder that is the final product are improved by using such a precipitate. The reaction temperature can be set in a range from 0° C. to 50° C., and is preferably in a range from 35° C. to 45° C. As a total concentration of metal ions, the reaction solution concentration is preferably in a range from 0.65 mol/L to 0.85 mol/L, and more preferably in a range from 0.7 mol/L to 0.84 mol/L. The reaction pH is preferably in a range from 5 to 9, and more preferably in a range from 6.5 to 8.

The powder particle size, powder shape, and particle size distribution of the magnetic powder that is ultimately formed is generally determined by the anisotropic magnetic powder particles formed in the precipitation step. The powder is preferably of a size and distribution such that when the particle size of the formed particles is measured using a laser diffraction-type wet particle size distribution meter, the particle size of all of the powder is substantially within a range from 0.05 μm to 20 μm, and preferably within a range from 0.1 μm to 10 μm. Additionally, the average particle size of the anisotropic magnetic powder particles is measured as a particle size corresponding to a cumulative volume of 50% from the small particle size side in the particle size distribution, and is preferably within a range from 0.1 μm to 10 μm.

After the precipitate is separated, the solvent is preferably removed from the separated product, in order to suppress aggregation of the precipitate and changes in the particle size distribution, the particle size of the powder, or the like when the precipitate is redissolved in the remaining solvent and the solvent evaporates in the heat treatment of the subsequent oxidation step. When, for example, water is used as the solvent, a specific example of the method for removing the solvent includes drying in an oven at a temperature in a range from 70° C. to 200° C. for a time in a range from 5 hours to 12 hours.

After the precipitation step, steps of separating and washing the resulting precipitate may be included. The washing step is appropriately carried out until the conductivity of the supernatant solution becomes 5 mS/m² or less. As the step of separating the precipitate, for example, a filtration method, a decantation method, or the like can be used after a solvent (preferably water) is added to the formed precipitate and mixed.

### Oxidation Step

The oxidation step is a step of firing the precipitate formed in the precipitation step to form an oxide containing Sm and Fe. For example, the precipitate can be converted to an oxide by heat treatment. When the precipitate is heat treated, the heat treatment must be implemented in the presence of oxygen, and for example, the heat treatment can be carried out in an air atmosphere. Also, because the heat treatment must be carried out in the presence of oxygen, oxygen atoms are preferably included in a non-metal portion in the precipitate.

The heat treatment temperature (hereinafter, the oxidation temperature) in the oxidation step is not particularly limited, but is preferably in a range from 700° C. to 1300° C., and more preferably in a range from 900° C. to 1200° C. At a temperature of less than 700° C., the oxidation is insufficient, and when the temperature exceeds 1300° C., the targeted shape, average particle size, and particle size distribution of the magnetic powder tend not to be obtained. The heat treatment time is also not particularly limited, but is preferably in a range from 1 hour to 3 hours.

The formed oxide is an oxide particle in which Sm and Fe are sufficiently mixed microscopically, and the shape of the precipitate, the particle size distribution, and the like are reflected.

### Pretreatment Step

The pretreatment step is a step of heat treating an oxide containing Sm and FE in a reducing gas atmosphere to form a partial oxide in which a portion of the oxide is reduced.

Here, the partial oxide refers to an oxide in which a portion of the oxide is reduced. The oxygen concentration in the oxide is not particularly limited, but is preferably 10 mass % or less, and more preferably 8 mass % or less. When the concentration exceeds 10 mass %, the generation of heat in reduction with Ca becomes large in the reduction step, and the firing temperature increases, and thereby particles with abnormal particle growth tend to be formed. Here, the oxygen concentration of the partial oxide can be measured by a non-dispersive infrared absorption method (ND-IR).

The reducing gas is selected, as appropriate, from hydrogen (H₂), carbon monoxide (CO), hydrocarbon gases such as methane (CH₄), and the like, but in terms of cost, hydrogen gas is preferable. The flow rate of the gas is adjusted, as appropriate, within a range in which the oxide does not scatter. The heat treatment temperature (hereinafter, pretreatment temperature) in the pretreatment step is in a range from 300° C. to 950° C., preferably 400° C. or higher, and more preferably 750° C. or higher, and also preferably lower than 900° C. When the pretreatment temperature is 300° C. or higher, the reduction of the oxide containing Sm and Fe proceeds efficiently. When the pretreatment temperature is 950° C. or lower, particle growth and segregation of the oxide particles can be suppressed, and the desired particle size can be maintained. Additionally, when hydrogen is used as the reducing gas, preferably, the thickness of the oxide layer that is used is adjusted to 20 mm or less, and the dew point in the reaction furnace is adjusted to −10° C. or lower.

### Reduction Step

The reduction step is a step of heat treating the partial oxide in the presence of a reducing agent at a temperature in a range from 920° C. to 1200° C. to form alloy particles, and for example, reduction is carried out by causing the partial oxide to contact a calcium melt or calcium vapor. From the perspective of magnetic properties, the heat treatment temperature is preferably in a range from 950° C. to 1150° C., and more preferably in a range from 980° C. to 1100° C. From the perspective of more uniformly carrying out the reduction reaction, the heat treatment time is preferably less than 120 minutes, and more preferably less than 90 minutes, and the lower limit of the heat treatment time is preferably 10 minutes or longer, and more preferably 30 minutes or longer.

Metal calcium is used in a granular or powdered form, and the particle size of the metal calcium is preferably 10 mm or less. This can suppress aggregation during the reduction reaction more effectively. Furthermore, the metal calcium can be added at a ratio in a range from 1.1 times to 3.0 times the reaction equivalent (the stoichiometric amount required to reduce the Sm oxide, and when Fe is in the form of an oxide, the reaction equivalent includes the amount necessary to reduce the Fe oxide), and is preferably added at a ratio in a range from 1.5 times to 2.0 times the reaction equivalent.

In the reduction step, a disintegration accelerator can be used as necessary along with metal calcium, which is a reducing agent. This disintegration accelerator is used, as appropriate, to promote disintegration and granulation of products during a rinsing step described below, and examples of the disintegration accelerator include alkaline earth metal salts such as calcium chloride, and alkaline earth oxides such as calcium oxide. These disintegration accelerators are used at a proportion in a range from 1 mass % to 30 mass %, and preferably in a range from 5 mass % to 28 mass %, per the Sm oxide used as the Sm source.

### Nitriding Step

The nitriding step is a step of nitriding the alloy particles formed in the reduction step to form anisotropic magnetic particles. Because the particulate precipitate formed in the aforementioned precipitation step is used, porous clump-shaped alloy particles are formed in the reduction step. As a result, these particles can be heat treated and nitrided immediately in a nitrogen atmosphere without being subjected to grinding, and thus nitriding can be uniformly implemented.

The heat treatment temperature (hereinafter, the nitriding temperature) in the nitriding treatment of the alloy particles is preferably in a range from 300° C. to 600° C., and particularly preferably in a range from 400° C. to 550° C., and the nitriding treatment is carried out by replacing the atmospheric air with a nitrogen atmosphere in this temperature range. The heat treatment time need only be set to a time that allows the alloy particles to be sufficiently and uniformly nitrided.

The product formed after the nitriding step includes, in addition to the magnetic particles, a byproduct of CaO, unreacted metal calcium, and the like, and these products may be combined in a sintered mass state. Thus, in this case, the product can be put into cooling water to separate the CaO and metal calcium as a calcium hydroxide (Ca(OH)₂) suspension from the magnetic particles. Furthermore, the remaining calcium hydroxide may be sufficiently removed by washing the magnetic particles with acetic acid or the like.

The SmFeN-based anisotropic magnetic powder has a Th₂Zn₁₇ type crystal structure and is a nitride that is represented by the general formula SmₓFe_{100-x-y}N_{y} and contains the rare earth metal samarium (Sm), iron (Fe), and nitrogen (N). Here, preferably, x is in a range from 8.1 atom % to 10 atom %, y is in a range from 13.5 atom % to 13.9 atom %, and the balance is mainly Fe.

The average particle size of the SmFeN-based anisotropic magnetic powder is in a range from 2 μm to 5 μm, and preferably in a range from 2.5 μm to 4.8 μm. When the average particle size is less than 2 μm, the filling amount of magnetic powder in the bonded magnet decreases, and thus magnetization is reduced, and when the average particle size exceeds 5 μm, the coercivity of the bonded magnet tends to decrease. Here, the average particle size is a particle size measured in dry conditions using a laser diffraction-type particle size distribution measurement device.

The particle size D10 of the SmFeN-based anisotropic magnetic powder is in a range from 1 μm to 3 μm, and preferably in a range from 1.5 μm to 2.5 μm. When particle size D10 is less than 1 μm, the filling amount of the magnetic powder in the bonded magnet decreases, and thus magnetization is reduced, and when the particle size D10 exceeds 3 μm, the coercivity of the bonded magnet tends to decrease. Here, D10 is a particle size at which the integrated value of the volume-based particle size distribution of the SmFeN-based anisotropic magnetic powder is equivalent to 10%.

The particle size D50 of the SmFeN-based anisotropic magnetic powder is in a range from 2.5 μm to 5 μm, and is preferably in a range from 2.7 μm to 4.8 μm. When the particle size D50 is less than 2.5 μm, the filling amount of magnetic powder in the bonded magnet decreases, and thus magnetization is reduced, and when the particle size D50 exceeds 5 μm, the coercivity of the bonded magnet tends to decrease. Here, D50 is a particle size at which the integrated value of the volume-based particle size distribution of the SmFeN-based anisotropic magnetic powder is equivalent to 50%.

The particle size D90 of the SmFeN-based anisotropic magnetic powder is in a range from 3 μm to 7 μm, and preferably in a range from 4 μm to 6 μm. When the particle size D90 is less than 3 μm, the filling amount of magnetic powder in the bonded magnet decreases, and thus magnetization is reduced, and when the particle size D90 exceeds 7 μm, the coercivity of the bonded magnet tends to decrease. Here, D90 is a particle size at which the integrated value of the volume-based particle size distribution of the SmFeN-based anisotropic magnetic powder is equivalent to 90%.

A span defined as span=(D90-D10)/D50 for the SmFeN-based anisotropic magnetic powder is 2 or less, and preferably 1.5 or less from the perspective of coercivity.

The circularity of the SmFeN-based anisotropic magnetic powder is not particularly limited, but is preferably 0.5 or higher, and more preferably 0.6 or higher. When the circularity is less than 0.5, fluidity worsens, and thereby stress is applied between particles during molding, and thus the magnetic properties are reduced. Here, to measure circularity, an SEM image captured at 3000× is binarized through image processing, and the circularity of one particle is determined. The circularity specified in the present invention refers to an average value of circularity determined by measuring particles of an approximate quantity in a range from 1000 to 10000. In general, the circularity increases as the number of particles having a small particle size increases, and therefore the circularity is measured for particles having a particle size of 1 μm or greater. In the measurement of circularity, a defined equation of circularity=(4πS/L²) is used. Here, S is the two-dimensional projected area of the particle, and L is the two-dimensional projected circumferential length.

### Method for Producing Bonded Magnet Compound

The method for producing a bonded magnet compound of the present embodiment is characterized by including a step of forming a phosphate-coated SmFeN-based anisotropic magnetic powder, and a step of kneading the magnetic powder and polypropylene. Hot water resistance is improved by using polypropylene. The phosphate-coated SmFeN-based anisotropic magnetic powder of the bonded magnet compound is formed by the method described above.

### Kneading Step

In the step of kneading the phosphate-coated SmFeN-based anisotropic magnetic powder and the polypropylene, the mixture of the phosphate-coated SmFeN-based anisotropic magnetic powder and the polypropylene is kneaded at a temperature in a range from 180° C. to 300° C. using a kneader such as a single-screw kneader or a twin-screw kneader. For example, after the magnetic powder and the resin powder are mixed in a mixer, a strand is extruded by a twin-screw extruder, air cooled, and then cut to a size of several mm by a pelletizer, and thereby a bonded magnet compound in the shape of pellets can be formed.

The weight average molecular weight of the polypropylene to be used is preferably in a range from 20000 to 200000. When the weight average molecular weight is less than 20000, the mechanical strength of the bonded magnet after molding tends to decrease, and if the weight average molecular weight exceeds 200000, the viscosity of the bonded magnet compound tends to increase. Further, for the purpose of improving the bonding property with the magnetic powder subjected to the coupling treatment, the polypropylene is preferably acid-modified, and for example, a polypropylene that has been acid-modified using maleic anhydride is suitably used. The modification ratio of the acid to the polypropylene is preferably in a range from 0.1 wt. % to 10 wt. %. When the modification ratio is less than 0.1 wt. %, adherence with the magnetic powder becomes insufficient, and the mechanical strength and water resistance of the bonded magnet decrease. When the modification ratio exceeds 10 wt. %, the water absorption rate of the resin becomes high, and therefore the water resistance of the bonded magnet is reduced.

The content of the phosphate-coated SmFeN-based anisotropic magnetic powder in the bonded magnet compound is preferably in a range from 80 mass % to 95 mass %, and is more preferably in a range from 90 mass % to 95 mass % from the perspective of achieving high magnetic properties. The content of the polypropylene in the bonded magnet compound is preferably in a range from 3 mass % to 20 mass %, and is more preferably in a range from 5 mass % to 15 mass % from the perspective of ensuring fluidity.

In addition to the phosphate-coated SmFeN-based anisotropic magnetic powder and the polypropylene, a thermoplastic elastomer and an antioxidant such as a phosphorus-based antioxidant can be simultaneously kneaded. When a thermoplastic elastomer is contained, the mass ratio of polypropylene to the thermoplastic elastomer is preferably in a range from 90:10 to 50:50, and is more preferably in a range from 89:11 to 70:30 from the viewpoint of impact resistance. When a phosphorus-based antioxidant is further contained, the content of the phosphorus-based antioxidant in the bonded magnet compound is preferably in a range from 0.1 mass % to 2 mass %.

Examples of the resin in the water-resistant bonded magnet compound include, in addition to the abovementioned polypropylene (PP), crystalline resins having a low water absorption rate, such as polyphenylene sulfide (PPS), polyether ether ketone (PEEK), liquid crystal polymer (LCP), polyamide (PA), and polyethylene (PE).

A polymer alloy or mixture formed by mixing the above-described crystalline resin with an amorphous resin having a glass transition temperature (Tg) of 100° C. or higher, such as modified polyphenylene ether (m-PPE), cycloolefin polymer (COP) or cycloolefin copolymer (COC), can be used to improve hot water resistance. In the present invention, for example, a polymer alloy of modified polyphenylene ether (m-PPE) and polypropylene can be suitably used.

### Bonded Magnet Compound

The bonded magnet compound of the present embodiment is characterized by including a phosphate-coated SmFeN-based anisotropic magnetic powder and polypropylene. By including the phosphate-coated SmFeN-based anisotropic magnetic powder and polypropylene, the hot water resistance of the bonded magnet produced using these bonded magnet compounds is improved. The bonded magnet compound is formed by the method described above.

### Method for Producing Bonded Magnet

A bonded magnet can be manufactured by using the bonded magnet compound and an appropriate molding machine. Specifically, for example, a bonded magnet can be formed by melting the bonded magnet compound in a molding machine barrel, injection molding the molten bonded magnet compound into a mold to which a magnetic field is applied, aligning the easily-magnetized axes (orientation step), cooling and solidifying the material, and subsequently magnetizing with an air-core coil or a magnetizing yoke (magnetization step).

The barrel temperature is selected according to the type of resin to be used, and can be set to a range from 160° C. to 320° C., and similarly, the mold temperature can be set, for example to a range from 30° C. to 150° C. An oriented magnetic field in the orientation step is generated using an electromagnet or a permanent magnet, and the magnitude of the magnetic field is preferably 4 kOe or greater, and more preferably 6 kOe or greater. Furthermore, the magnitude of the magnetic field in the magnetization step is preferably 20 kOe or greater, and more preferably 30 kOe or greater.

### Bonded Magnet

A bonded magnet according to the present embodiment includes polypropylene and a phosphate-coated SmFeN-based anisotropic magnetic powder having a phosphate content of more than 0.5 mass %, and is characterized in that a retention rate of the total flux after a test of immersing the bonded magnet in 120° C. hot water and maintaining that state for 1000 hours is 95% or greater of the total flux before the test. When the total flux of the bonded magnet after the hot water resistance test in which the bonded magnet is immersed in 120° C. hot water and maintained in that state for 1000 hours is 95% or greater of the total flux before the test, such a result means that the hot water resistance is high. The retention rate of the total flux thereof is preferably 96% or higher and more preferably 97% or higher. The retention rate of the total flux can be measured under the conditions described in the Examples. Moreover, the bonded magnet is formed by the method described above.

Because the bonded magnet of the present embodiment has resistance to hot water, such a bonded magnet can be suitably used, for example, in a water pump or a driving source of a fuel pump in an automobile, a motorcycle, or the like.

### EXAMPLES

### Example 1

5.0 kg of FeSO₄·7H₂O was mixed and dissolved in 2.0 kg of pure water. In addition, 0.49 kg of Sm₂O₃ and 0.74 kg of 70% sulfuric acid were added and the mixture was stirred well to completely dissolve the material. Subsequently, pure water was added to the resulting solution to adjust the solution such that the final Fe concentration was 0.726 mol/L and the final Sm concentration was 0.112 mol/L, and thereby an SmFe sulfuric acid solution was prepared.

### Precipitation Step

Into 20 kg of pure water maintained at a temperature of 40° C., the entire amount of the prepared SmFe sulfuric acid solution was added dropwise while being stirred over a period of 70 minutes from the startup of the reaction, and at the same time, a 15% ammonia solution was added dropwise to adjust the pH to a range from 7 to 8. As a result, a slurry containing SmFe hydroxide was formed. The formed slurry was washed with pure water through decantation, after which the hydroxide was solid-liquid separated. The separated hydroxide was dried in an oven at 100° C. for 10 hours.

### Oxidation Step

The hydroxide formed in the precipitation step was fired at 1000° C. in air for 1 hour. The fired hydroxide was cooled, after which a red SmFe oxide was formed as a raw material powder.

### Pretreatment Step

100 g of the SmFe oxide was placed in a steel container such that the bulk thickness was 10 mm. The container was inserted into a furnace, and the pressure was reduced to 100 Pa, after which the temperature was increased to the pretreatment temperature of 850° C. while hydrogen gas was being introduced, and this state was maintained for 15 hours. The oxygen concentration was measured by the non-dispersive infrared absorption method (ND-IR) (using the EMGA-820 available from Horiba, Ltd.) and was found to be 5 mass %. Through this, it was found that the oxygen bonded to Sm was not reduced, and a black partial oxide in which 95% of the oxygen bonded to Fe was reduced was formed.

### Reduction Step

60 g of the partial oxide formed in the pretreatment step and 19.2 g of metal calcium having an average particle size of approximately 6 mm were mixed and inserted into a furnace. The inside of the furnace was evacuated to create a vacuum state, after which argon gas (Ar gas) was introduced. Fe—Sm alloy particles were formed by increasing the temperature to 1045° C. and maintaining that temperature for 45 minutes.

### Nitriding Step

Subsequently, the temperature inside the furnace was cooled to 100° C., after which the furnace was evacuated to a vacuum state, the temperature was increased to 450° C. while nitrogen gas was being introduced, and that state was maintained for 23 hours, and as a result, a clump-shaped product containing magnetic particles was formed.

### Rinsing Step

The clump-shaped product formed in the nitriding step was put into 3 kg of pure water and the mixture was stirred for 30 minutes. The formed solution was left standing, after which the supernatant was drained by decanting. The process of putting into pure water, stirring and decanting was repeated 10 times. Subsequently, 2.5 g of 99.9% acetic acid was added, and the mixture was stirred for 15 minutes. The formed solution was left standing, after which the supernatant was drained by decanting. The process of putting into pure water, stirring and decanting was repeated twice, after which the formed product was dehydrated and dried, and then subjected to mechanical crushing, and thereby an SmFeN-based anisotropic magnetic powder (average particle size of 3 μm) was formed.

### Phosphate Treatment Step

A phosphate treatment solution was prepared by mixing 85% ortho-phosphoric acid, sodium dihydrogen phosphate, and sodium molybdate dihydrate at a weight ratio of 1:6:1 (85% ortho-phosphoric acid:sodium dihydrogen phosphate:sodium molybdate dihydrate), and then adjusting the pH to 2 and the PO₄ concentration to 20 mass % using pure water and dilute hydrochloric acid. Subsequently, hydrogen chloride, namely 70 g of dilute hydrochloric acid, was added to a slurry containing 1000 g of the SmFeN-based anisotropic magnetic powder formed in the rinsing step and the mixture was stirred for 1 minute to remove the surface oxide film and contaminants, after which drainage and water injection were repeated until the conductivity of the supernatant became 100 μS/cm, and a slurry containing 10 mass % of the SmFeN-based anisotropic magnetic powder was formed. While the formed slurry was stirred, a total amount of 100 g of the prepared phosphate treatment solution was added into the treatment tank, after which the pH of the phosphate treatment reaction slurry was controlled to a range of 2.5±0.1 by adding 6 wt. % of hydrochloric acid as needed, and this state was maintained for 30 minutes. Subsequently, suction filtration, dehydration, and vacuum drying were carried out to form a phosphate-coated SmFeN-based anisotropic magnetic powder.

Oxidation Treatment Step after Phosphate Treatment Step

An amount of 1000 g of the phosphate-coated SmFeN-based anisotropic magnetic powder was gradually heated from room temperature in a mixed gas (oxygen concentration of 4%, 5 L/min) atmosphere of nitrogen and air, and heat treated at a maximum temperature of 230° C. for 8 hours, and an oxidation-treated phosphate-coated SmFeN-based anisotropic magnetic powder was formed.

### Example 2

An oxidation-treated phosphate-coated SmFeN-based anisotropic magnetic powder was formed in the same manner as in Example 1 with the exception that the heat treatment temperature in the oxidation treatment step was changed from 230° C. to 200° C.

### Comparative Example 1

An oxidation-treated phosphate-coated SmFeN-based anisotropic magnetic powder was formed in the same manner as in Example 1 with the exception that the heat treatment temperature in the oxidation treatment step was changed from 230° C. to 170° C.

### Comparative Example 2

The phosphate-coated SmFeN-based anisotropic magnetic powder in Example 1 was used, and the oxidation treatment after the phosphate treatment step was not implemented.

### Comparative Example 3

### Phosphate Treatment Step

Steps up to the rinsing step were implemented in the same manner as in Example 1 to form a magnetic powder. A phosphate treatment solution was prepared by mixing 85% ortho-phosphoric acid, sodium dihydrogen phosphate, and sodium molybdate dihydrate at a weight ratio of 1:6:1 (85% ortho-phosphoric acid:sodium dihydrogen phosphate:sodium molybdate dihydrate), and then adjusting the pH to 2.5 and the PO₄ concentration to 20 mass % using pure water and dilute hydrochloric acid. Subsequently, hydrogen chloride, namely 70 g of dilute hydrochloric acid, was added to a slurry containing 1000 g of the SmFeN-based anisotropic magnetic powder formed in the rinsing step and stirred for 1 minute to remove the surface oxide film and contaminants, after which drainage and water injection were repeated until the conductivity of the supernatant became 100 μS/cm, and a slurry containing 10 mass % of the SmFeN-based anisotropic magnetic powder was formed. While the formed slurry was stirred, a total amount of 100 g of the prepared phosphate treatment solution was added into the treatment vessel. The pH of the reaction slurry was increased from 2.5 to 6 over 5 minutes. After 15 minutes of stirring, suction filtration, dehydration, and vacuum drying were carried out to form a phosphate-coated SmFeN-based anisotropic magnetic powder.

Oxidation Treatment Step after Phosphate Treatment Step

1000 g of the phosphate-treated SmFeN-based anisotropic magnetic powder was gradually heated from room temperature in a mixed gas (oxygen concentration of 4%, 5 L/min) atmosphere of nitrogen and air, and heat treated at a maximum temperature of 230° C. for 8 hours, and an oxidation-treated phosphate-coated SmFeN-based anisotropic magnetic powder was formed.

### Comparative Example 4

An oxidation-treated phosphate-coated SmFeN-based anisotropic magnetic powder was formed in the same manner as in Comparative Example 3 with the exception that the heat treatment temperature in the oxidation treatment step was changed from 230° C. to 200° C.

### Comparative Example 5

An oxidation-treated phosphate-coated SmFeN-based anisotropic magnetic powder was formed in the same manner as in Comparative Example 3 with the exception that the heat treatment temperature in the oxidation treatment step was changed from 230° C. to 170° C.

### Comparative Example 6

The phosphate-coated SmFeN-based anisotropic magnetic powder formed in Comparative Example 3 was used, and the oxidation treatment after the phosphate treatment step was not implemented.

### Comparative Example 7

### Reduction Step 2

A crucible filled with a mixed powder of 52.5 g of iron powder having an average particle size (D50) of approximately 50 μm, 21.3 g of a samarium oxide powder having an average particle size (D50) of 3 μm, and 10.5 g of metal calcium was inserted into a furnace. The inside of the furnace was evacuated to create a vacuum state, after which argon gas (Ar gas) was introduced. Fe—Sm alloy particles were formed by increasing the temperature to 1150° C. and maintaining that temperature for 5 hours.

### Nitriding Step 2

Subsequently, the Fe—Sm alloy particles were heat treated at 420° C. for 23 hours in an ammonia-hydrogen mixed gas, and a clump-shaped product containing the magnetic particles was formed.

### Rinsing Step 2

The clump-shaped product formed in the nitriding step was put into 3 kg of pure water and the mixture was stirred for 30 minutes. The formed solution was left standing, after which the supernatant was drained by decanting. The process of putting into pure water, stirring and decanting was repeated 10 times. Subsequently, 2.5 g of 99.9% acetic acid was added, and the mixture was stirred for 15 minutes. The formed solution was left standing, after which the supernatant was drained by decanting. The process of putting into pure water, stirring and decanting was repeated twice. Subsequently, the formed product was dehydrated and dried, and thereby an SmFeN-based anisotropic magnetic powder (average particle size of 30 μm) was formed.

### Phosphate Treatment Step 2

g of the formed magnetic powder, 0.44 g of an 85% ortho-phosphoric acid aqueous solution, 100 mL of isopropanol (IPA), and 200 g of alumina beads having a diameter of 10 mm were stored in a glass jar, the glass jar was sealed and the contents were ground for 120 minutes using a vibrating ball mill. Subsequently, the slurry was filtered, and then vacuum dried at 100° C., and a phosphate-coated SmFeN-based anisotropic magnetic powder (average particle size of 1.5 μm) was formed.

Oxidation Treatment Step 2 after Phosphate Treatment Step

g of the phosphate-treated SmFeN-based anisotropic magnetic powder was gradually heated from room temperature in a mixed gas (oxygen concentration of 4%, 5 L/min) atmosphere of nitrogen and air, and heat treated at a maximum temperature of 150° C. for 8 hours, and an oxidation-treated phosphate-coated SmFeN-based anisotropic magnetic powder was formed.

### Comparative Example 8

An oxidation-treated phosphate-coated SmFeN-based anisotropic magnetic powder was formed in the same manner as in Comparative Example 7 with the exception that the heat treatment temperature in the oxidation treatment step was changed from 150° C. to 200° C.

### Magnetic Powder Evaluation

### Magnetic Powder Br, iHc

The magnetic properties (residual magnetization Gr, intrinsic coercivity iHc) of the magnetic powders formed in Examples 1 and 2 and Comparative Examples 1 to 8 were measured using a vibrating-sample magnetometer (VSM) (available from Riken Denshi Co., Ltd., model: BHV-55). In addition, the residual magnetic flux density Br (units: kG) was calculated from the residual magnetization Gr (units: emu/g) using the equation of (Br=4×π×ρ×σr, ρ: density=7.66 g/cm 3). The results are shown in Table 1.

### PO₄ Adhesion Amount

The phosphorus concentration in each of the magnetic powders formed in Examples 1 and 2 and Comparative Examples 1 to 8 was measured using inductively coupled plasma atomic emission spectroscopy (ICP-AES), and the phosphorus concentration was converted to the molecular weight of PO₄. The results are shown in Table 1.

### DSC Exothermic Onset Temperature

The exothermic onset temperature of each of the magnetic powders formed in Examples 1 and 2 and Comparative Examples 1 to 8 was measured by weighing 20 mg of the magnetic powder, and subjecting the magnetic powder to differential scanning calorimetry (DSC) analysis using a high-temperature differential scanning calorimeter (DSC6300, available from Hitachi High-Tech Science Corporation) under measurement conditions including an air atmosphere (200 mL/min), a temperature from room temperature to 400° C. (heating rate: 20° C./min), and a reference of alumina (20 mg). The DSC results are shown in Table 1. A high exothermic onset temperature means that the phosphate coating is more densely formed because heat generation due to oxidation does not easily occur.

### STEM-EDX Mapping

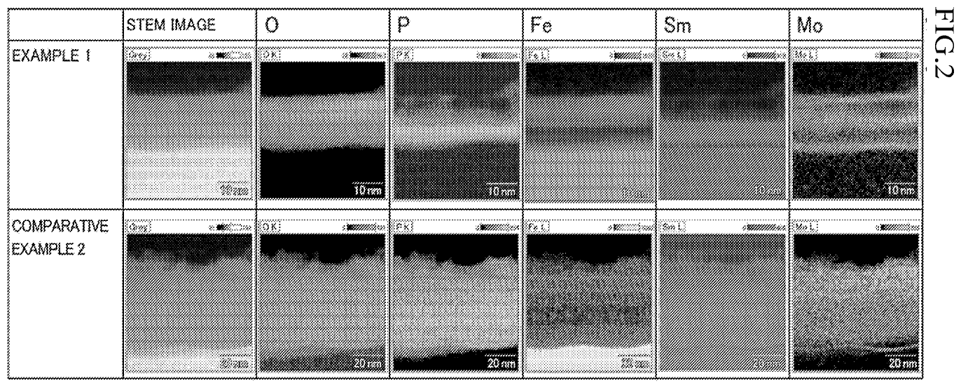

The magnetic powders formed in Example 1 and Comparative Example 2 were respectively dispersed in an epoxy resin and solidified, and then cross-sectioned with a cross-section polisher to form a cross-section sample for measurement. A STEM image (acceleration voltage of 200 kV) of each of the formed samples was measured using a scanning transmission electron microscope (STEM; available from JEOL. Ltd.) and an energy dispersive X-ray analyzer (EDX; available from JEOL, Ltd.). FIG. 2 shows the STEM-EDX mapping analysis results (elements: O, P, Fe, Sm, Mo). In FIG. 2, it can be confirmed that Example 1 in which the oxidation treatment was implemented has a plurality of layers after the oxidation treatment, in contrast to Comparative Example 2 in which the oxidation treatment was not implemented. That is, in Example 1, five regions can be confirmed in a direction from the outermost surface of the SmFeN-based anisotropic magnetic powder serving as the base towards the outer side of the phosphate coating, namely, (1) an oxide layer in which Mo is concentrated, (2) a phosphate coating in which Sm is concentrated, (3) a phosphate layer in which Mo and Fe are concentrated, (4) an oxide layer in which Fe is concentrated, and (5) an oxide layer in which Mo and Fe are concentrated. On the other hand, in Comparative Example 2, while a layer corresponding to (2) can be confirmed on the outermost surface of the SmFeN-based anisotropic magnetic powder serving as the base, a large portion of this layer is a phosphate coating containing Fe, Sm, and Mo, and a significant change in the layers corresponding to (1) and (3) to (5) in Example 1 cannot be confirmed.

### STEM-EDX Line Analysis

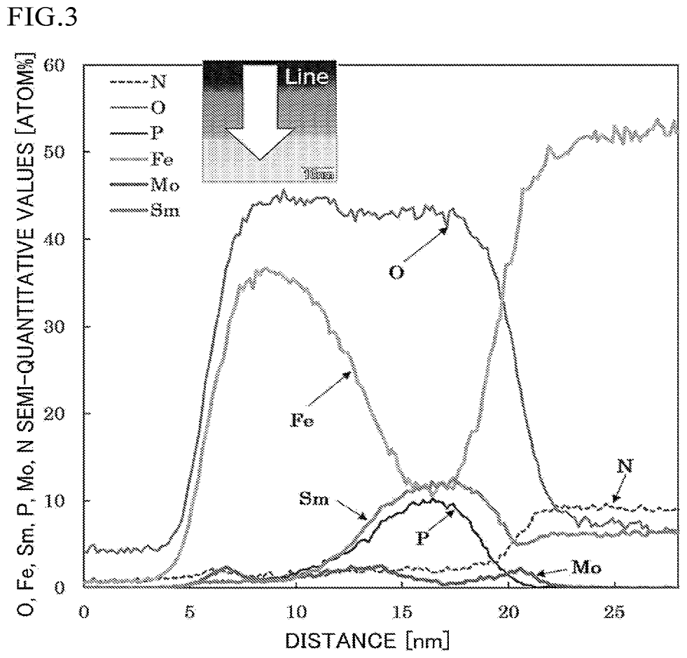

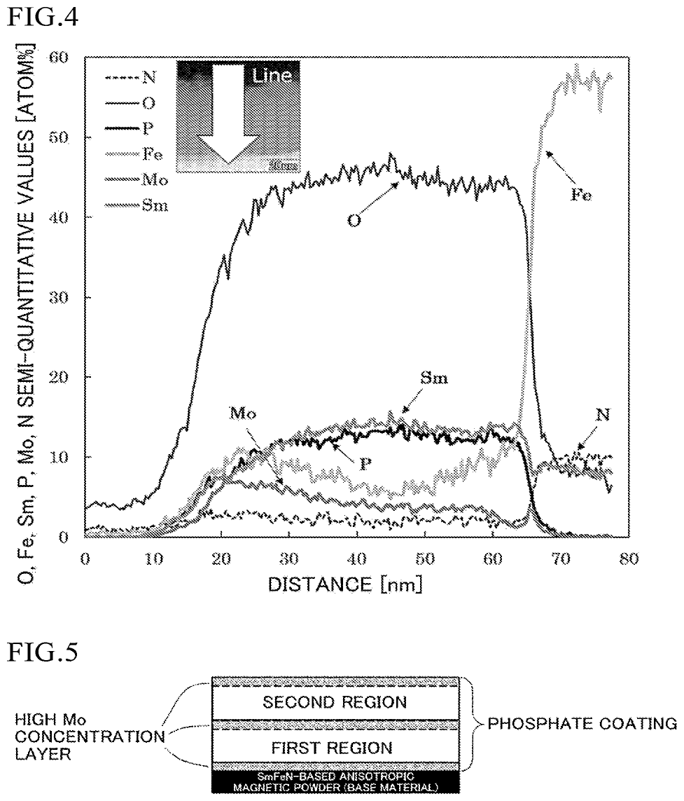

FIGS. 3 and 4 illustrate EDX line analyses corresponding to the arrow at the interface between the phosphate coating and the SmFeN-based anisotropic magnetic powder of Example 1 and Comparative Example 2, respectively. In Example 1 of FIG. 3, three divided Mo peaks (at positions of approximately 21 nm, 13 nm, and 7 nm) and peaks at which Sm and Fe are respectively contained at high concentrations are observed and match the results of FIG. 2. On the other hand, in Comparative Example 2 of FIG. 4, Mo has a peak at a position near 65 nm corresponding to the outermost surface of the SmFeN-based anisotropic magnetic powder and has a characteristic tendency of gradually increasing towards the outer side of the phosphate coating, but a large portion is inferred to be a composite phosphate containing samarium phosphate as a main component.

From the above, it is conceivable that when the phosphate coating of Comparative Example 2 was subjected to the oxidation treatment at a high temperature of 200° C. or higher, each metal element (Fe, Sm, and Mo) mutually diffused with oxygen, and the phosphate coating was thermodynamically changed into a plurality of more stable layers, and as a result, the coating of Example 1 was formed. The magnetic powder having the coating subjected to the oxidation treatment in this manner exhibits better water resistance as a bonded magnet.

### Silica Treatment Step

Each of the magnetic powders formed in Example 1 and 2 and Comparative Examples 1 to 8 was mixed with ethyl silicate 40 and 12.5 wt. % ammonia water at a weight ratio of 97.8:1.8:0.4 (magnetic powder:ethyl silicate 40:ammonia water) using a mixer. The mixture was heated at 200° C. in vacuum state, and an SmFeN-based anisotropic magnetic powder having a silica thin film formed on the particle surface was formed.

### Silane Coupling Treatment

The SmFeN-based anisotropic magnetic powder formed as described above and on which a silica thin film was formed and 12.5 wt. % ammonia water were mixed in a mixer, after which an ethanol solution of 50 wt. % 3-aminopropyltriethoxysilane was mixed therewith using a mixer. The weight ratio of the SmFeN-based anisotropic magnetic powder on which the silica thin film was formed, the 12.5 wt. % ammonia water and the ethanol solution of 3-aminopropyltriethoxysilane was 99:0.2:0.8, respectively. The mixture was dried in a nitrogen atmosphere at 100° C. for 10 hours, and a silane-coupled SmFeN-based anisotropic magnetic powder was formed.

### Kneading and Molding Step

The silane-coupled SmFeN magnetic powder, polypropylene (maleic anhydride modification rate: 1 wt. %, weight average molecular weight: 90000), and an antioxidant were mixed at a weight ratio of 91.5:8:0.5, respectively, and kneaded with a twin-screw extruder, and a bonded magnet compound was formed. The kneading temperature at this time was 210° C.

### Molding Step

The compound was heated to 240° C. in the barrel of the injection molding machine, and while a magnetic field of 9 kOe was applied, the molten bonded magnet compound was injection molded into a mold for which the temperature was adjusted to 90° C., and a cylindrical bonded magnet molded article having a diameter (Φ) of 10 mm and a height (t) of 7 mm was formed for use in a water resistance evaluation.

### Magnet Evaluation

### Magnet iHc

The bonded magnet molded article for water resistance evaluation was placed in an air-core coil and then magnetized with a magnetizing magnetic field of 60 kOe, after which the magnetic properties (magnet-inherent coercivity iHc after molding) were measured using a BH tracer. The results are shown in Table 1.

### Hot Water Resistance of Magnet

The bonded magnet molded article for evaluation of water resistance was magnetized by a magnetizing magnetic field of 60 kOe in the air-core coil, and then dirt and oil on the surface of the magnet were wiped off. Subsequently, the magnet and water sufficient to immerse the entire magnet were supplied into a pressure-resistant container, the container was held for a predetermined amount of time in an oven at 120° C., and after 1000 hours, an irreversible flux loss was determined on the basis of a change in the total flux of the magnet before and after the test. Note that for the total flux, the bonded magnet molded article was placed inside a search coil, the amount of change in magnetic flux inside the search coil was measured by pulling out the bonded magnet molded article to outside the search coil, using a flux meter (available from Nihon Denji Sokki Co., Ltd.; model: NFX-1000), and the irreversible flux loss was determined by the following equation.

Irreversible flux loss (%)=(total flux (value at 0 hr)−total flux (value after predetermined amount of time))/total flux (value at 0 hr)×100

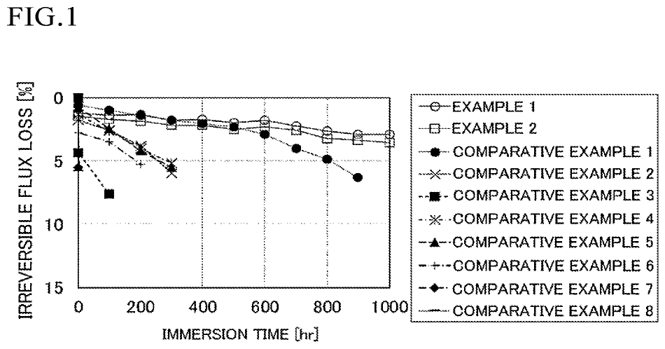

The time at which the irreversible flux loss reached 5% is shown in Table 1, and the relationships between the treatment time and the irreversible flux loss is illustrated in FIG. 1.

TABLE 1

| | Conditions | | | | | | | | |
|---|---|---|---|---|---|---|---|---|---|
| | | pH | | Magnetic Powder Evaluation Results | | | | Magnet Evaluation Results | |
| | | Adjustment | | | | | DSC | | Time (hr) to |
| | | during | Gradual | | | PO₄ | Exothermic | | reach water |
| | | Phosphoric | Oxidation | | | Adhesion | Onset | | resistant |
| | Treatment | Acid | Temperature | Br | iHc | Amount | Temperature | iHc | demagnetization |
| | Medium | Treatment | ° C. | kG | kOe | wt % | ° C. | kOe | of 5% |
| Example 1 | Water | 2.5 | 230 | 12.6 | 18.1 | 1.4 | 288 | 16.9 | >1000 |
| Example 2 | Water | 2.5 | 200 | 12.6 | 20.2 | 1.1 | 261 | 18.7 | >1000 |
| Comparative | Water | 2.5 | 170 | 12.7 | 20.2 | 1.1 | 222 | 18.9 | 810 |
| Example 1 | | | | | | | | | |
| Comparative | Water | 2.5 | None | 13.0 | 19.8 | 1.1 | 210 | 16.1 | 255 |
| Example 2 | | | | | | | | | |
| Comparative | Water | No pH | 230 | 12.5 | 13.1 | 0.5 | 259 | 12.4 | 20 |
| Example 3 | | adjustment | | | | | | | |
| | | (2.5→6) | | | | | | | |
| Comparative | Water | No pH | 200 | 12.6 | 15.8 | 0.5 | 247 | 14.5 | 280 |
| Example 4 | | adjustment | | | | | | | |
| | | (2.5→6) | | | | | | | |
| Comparative | Water | No pH | 170 | 12.9 | 15.8 | 0.5 | 215 | 14.8 | 265 |
| Example 5 | | adjustment | | | | | | | |
| | | (2.5→6) | | | | | | | |
| Comparative | Water | No pH | None | 13.1 | 15.2 | 0.5 | 165 | 14.2 | 180 |
| Example 6 | | adjustment | | | | | | | |
| | | (2.5→6) | | | | | | | |
| Comparative | IPA | No pH | 150 | 11.5 | 12.4 | 1.7 | 165 | 11.4 | 1 |
| Example 7 | | adjustment | | | | | | | |
| Comparative | IPA | No pH | 200 | 10.4 | 12.5 | 1.7 | 245 | 11.1 | 1 |
| Example 8 | | adjustment | | | | | | | |

From Table 1, it was confirmed that the magnetic powders formed in Examples 1 and 2 had higher DSC exothermic onset temperatures than those of Comparative Examples 1 to 8, and exhibited good denseness, thickness, and oxidation resistance of the phosphate coating. Further, from Table 1 and FIG. 1, it was confirmed that the bonded magnets of Examples 1 and 2 had the irreversible flux loss of 5% or less even after being immersed in hot water for 1000 hours, and were good in hot water resistance.

1-14. (canceled)

15. A method for producing a phosphate-coated SmFeN-based anisotropic magnetic powder, the method comprising:
a phosphate treatment of adding an inorganic acid to a slurry containing an SmFeN-based anisotropic magnetic powder, water, and a phosphate compound to adjust a pH of the slurry to a range from 1 to 4.5 to form an SmFeN-based anisotropic magnetic powder having a surface on which a phosphate coating is formed; and
oxidizing by heat treating the SmFeN-based anisotropic magnetic powder having the surface on which the phosphate coating is formed, in an oxygen-containing atmosphere at a temperature in a range of 200° C. to 330° C., to form the phosphate-coated SmFeN-based anisotropic magnetic powder.

16. The method for producing a phosphate-coated SmFeN-based anisotropic magnetic powder according to claim 15, wherein in the oxidizing, the heat treating is carried out at a temperature in a range of 200° C. to 250° C.

17. The method for producing a phosphate-coated SmFeN-based anisotropic magnetic powder according to claim 15, wherein a content of a phosphate in the phosphate-coated SmFeN-based anisotropic magnetic powder is greater than 0.5 mass %.

18. The method for producing a phosphate-coated SmFeN-based anisotropic magnetic powder according to claim 15, wherein
in the phosphate-coated SmFeN-based anisotropic magnetic powder formed in the step of oxidizing, the phosphate coating comprises a first region,
an Sm atomic concentration in the first region is higher than an Sm atomic concentration in a SmFeN-based anisotropic magnetic powder, and
the Sm atomic concentration in the first region is in a range from 0.5 times to 4 times an Fe atomic concentration in the first region.

19. The method for producing a phosphate-coated SmFeN-based anisotropic magnetic powder according to claim 18, wherein
the phosphate coating further comprises a second region on the first region, and
an Sm atomic concentration in the second region is not greater than ⅓ times an Fe atomic concentration in the second region.

20. The method for producing a phosphate-coated SmFeN-based anisotropic magnetic powder according to claim 15, wherein in the phosphate treatment, the pH of the slurry is adjusted over a period of 10 minutes or longer.

21. The method for producing a phosphate-coated SmFeN-based anisotropic magnetic powder according to claim 15, wherein in the phosphate treatment, the pH of the slurry is adjusted to a range from 1.6 to 3.9.

22. The method for producing a phosphate-coated SmFeN-based anisotropic magnetic powder according to claim 15, wherein the phosphate compound used in the phosphate treatment includes an inorganic phosphate compound.

23. The method for producing a phosphate-coated SmFeN-based anisotropic magnetic powder according to claim 21, wherein the phosphate compound used in the phosphate treatment includes an inorganic phosphate compound.

24. The method for producing a phosphate-coated SmFeN-based anisotropic magnetic powder according to claim 15, wherein
a content of a phosphate in the phosphate-coated SmFeN-based anisotropic magnetic powder is greater than 0.5 mass %,
the phosphate coating present on a surface of the phosphate-coated SmFeN-based anisotropic magnetic powder comprises a first region and a second region, and an Sm atomic concentration in the first region is higher than an Sm atom concentration in the SmFeN-based anisotropic magnetic powder,
the Sm atomic concentration in the first region is in a range from 0.5 times to 4 times an Fe atomic concentration in the first region, and
the second region is present on the first region, and an Sm atomic concentration in the second region is not more than ⅓ times an Fe atomic concentration in the second region.

25. A method for producing a bonded magnet compound, the method comprising kneading polypropylene with the phosphate-coated SmFeN-based anisotropic magnetic powder formed by the method according to claim 15.

26. A bonded magnet comprising
polypropylene; and
a phosphate-coated SmFeN-based anisotropic magnetic powder having a content of a phosphate greater than 0.5 mass %,
wherein a retention rate of a total flux after a test of immersing the bonded magnet in 120° C. hot water and maintaining the state thereof for 1000 hours is 95% or greater relative to a total flux before the test.

27. The bonded magnet according to claim 26, wherein an exothermic onset temperature of the phosphate-coated SmFeN-based anisotropic magnetic powder according to differential scanning calorimetry (DSC) is 170° C. or higher.

28. A phosphate-coated SmFeN-based anisotropic magnetic powder, wherein
a content of a phosphate is greater than 0.5 mass %,
a phosphate coating present on a surface of an SmFeN-based anisotropic magnetic powder comprises a first region and a second region, and an Sm atomic concentration in the first region is higher than an Sm atom concentration in the SmFeN-based anisotropic magnetic powder,
the Sm atomic concentration of the first region is in a range from 0.5 times to 4 times an Fe atomic concentration in the first region, and
the second region is present on the first region, and an Sm atomic concentration of the second region is not more than ⅓ times an Fe atomic concentration in the second region.

29. The phosphate-coated SmFeN-based anisotropic magnetic powder according to claim 28, wherein an exothermic onset temperature according to differential scanning calorimetry (DSC) is 170° C. or higher.

30. A bonded magnet comprising the phosphate-coated SmFeN-based anisotropic magnetic powder according to claim 28 and a resin.
